(19) United States
(12) Patent Application Publication
(10) Pub. No.: US 2025/0211541 A1
(43) Pub. Date: Jun. 26, 2025

(54) Open Network Slice Configuration Framework

(71) Applicant: T-Mobile USA, Inc., Bellevue, WA (US)

(72) Inventors: Emile Minh Tran, Sammamish, WA (US); Antoine T. Tran, Bellevue, WA (US); Do Kyu Lee, Mercer Island, WA (US)

(21) Appl. No.: 18/390,391

(22) Filed: Dec. 20, 2023

(51) Int. Cl. H04L 47/31; H04L 47/24

(52) U.S. Cl. CPC H04L 47/31; H04L 47/24

(57) ABSTRACT

Techniques are described herein for locally (e.g., on a user device) assigning a tag to untagged network traffic in order to allocate the network traffic to an appropriate network slice. In embodiments, the techniques may involve receiving network traffic that is untagged, determining information about the network traffic, identifying, based on the information about the network traffic, a set of attribute values associated with the network traffic, and assigning, based on the set of attribute values and based on configuration data, a tag to the network traffic. In embodiments, the network traffic is then allocated to a network slice associated with the assigned tag to be transmitted over a local network connection.

### BACKGROUND

Cellular networks are frequently used to enable communication between various mobile devices. In a cellular network (such as the Global System for Mobile communication (GSM) and TETRA (TErrestrial Trunked RAdio)), a geographical region is divided into a number of cells, each of which is served by a base station (also referred to as a Base Transceiver Station (BTS)). Such cellular networks are typically made up of a number of base stations that are geographically distributed throughout the geographical region in a way that maximizes wireless transmission coverage for the cellular network.

In recent years, cellular technology has advanced to its fifth generation (5G). One feature that may be implemented in 5G cellular networks is network slicing, which is a network architecture that enables the creation of independent logical networks (e.g., network slices) on the same physical network infrastructure. In 5G network slicing, each of a number of network slices may be dedicated to a different type or category of network traffic.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 is a block diagram that illustrates a wireless telecommunication network architecture in which aspects of the disclosed technology may be implemented in accordance with embodiments.

FIG. 2 depicts a component diagram of an example system to be implemented in a network in order to enable allocation of network traffic to a network slice in accordance with at least some embodiments.

FIG. 3 depicts a block diagram illustrating a process for allocating network traffic to a network slice as implemented within a user device in accordance with at least some embodiments.

FIG. 4 depicts a component diagram illustrating a number of components that may be implemented to achieve tagging and allocation of network traffic in accordance with embodiments.

FIG. 5 depicts a block diagram illustrating a process for updating configuration data to be used in tagging on a user device in accordance with some embodiments.

FIG. 6 depicts a block diagram illustrating exemplary techniques for provisioning configuration data onto one or more user devices in accordance with some embodiments.

FIG. 7 depicts a flow diagram illustrating an exemplary process for generating tag assignment data to be used in network traffic allocation in accordance with at least some embodiments.

FIG. 8 shows an example computer architecture for a computing device 800 capable of executing program components for implementing the functionality described above.

### DETAILED DESCRIPTION

This disclosure describes techniques that may be performed to enable efficient allocation of network traffic to an appropriate network slice, even when such network traffic is not initially tagged by an origination device/application. Network architectures may include network segments that are logically partitioned and configured to optimally transmit a particular type of network traffic. Such a partition may be referred to as a network slice. Conventionally, network traffic may be assigned to an appropriate network slice based on a tag assigned to that network traffic. However, in the case that network traffic is untagged such network traffic would conventionally be allocated to a default network slice, resulting in suboptimal data packet transmission.

In embodiments, a tagging module is implemented on a user device to identify untagged network traffic as it is generated by software applications executed on that user device. Upon detecting untagged network traffic, the tagging module is able to determine an appropriate tag to be applied to the network traffic so that it can be allocated to a respective network slice as it leaves the user device.

The tagging module determines a tag for untagged network traffic based on information included in configuration data that is provisioned onto the user device. In some cases, the tagging module uses one or more machine learning models to identify new correlations between network traffic attribute values and a tag. Such new correlations can be added to the configuration data, which may then be aggregated at a central repository and/or distributed to other user devices.

Embodiments of the disclosure provide for a number of advantages over conventional systems. For example, by performing network slice tagging/allocation on the user device, the network is able to take advantage of efficiencies at the local network level. Even if network slice tagging/allocation is performed on an access point (e.g., a base station, etc.), network traffic that is initially untagged would need to be conveyed between the user device and the access point over a default slice, resulting in suboptimal transmission at the local network level (e.g., between the user device and the access point). This can create a data flow bottleneck that has a negative impact on the entire communication. Accordingly, implementation of network slice tagging on the user device itself can have a huge impact on the overall communication.

Furthermore, in some embodiments of the disclosed system, network slice tagging is performed within an application wrapper that includes an instance of a software application. In such embodiments, network slicing capabilities can be made available to a software application that does not otherwise have such capabilities (e.g., legacy software applications). Accordingly, the disclosure allows for additional functionality to be made available to software applications without the need to modify such software applications.

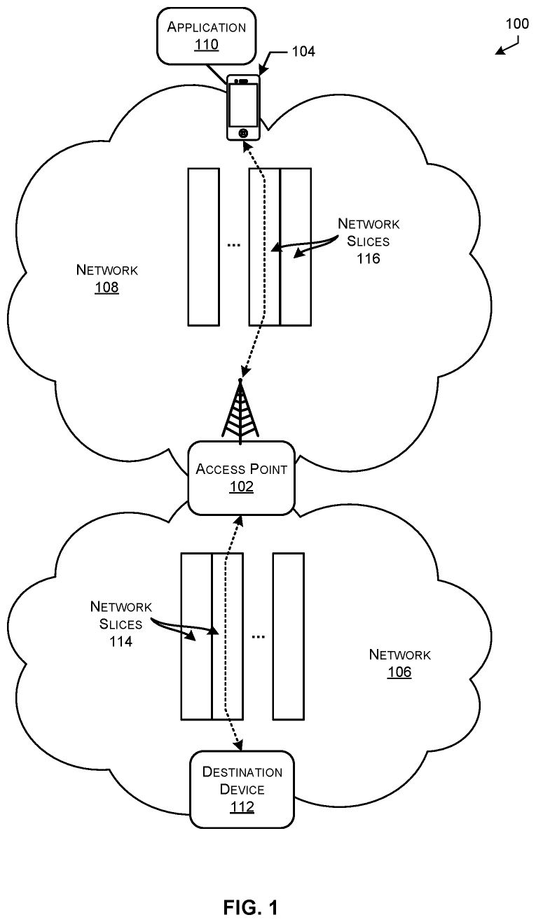

FIG. 1 is a block diagram that illustrates a wireless telecommunication network architecture 100 in which aspects of the disclosed technology may be implemented in accordance with embodiments. The architecture 100 includes at least one access point 102 in wireless communication with at least one user device 104. The access point 102 may provide the user device 104 with ingress/egress to a network 106. In some cases, one or more user device 104 may operate on a network 108, which might be a local area network (LAN).

An access point 102 may be any suitable electronic device that is capable of managing access to one or more networks (e.g., network 106). In some embodiments, the access point 102 may be, or may be implemented within, a base station. A base station is a type of network access node (NAN) that can also be referred to as a cell site, a base transceiver station, or a radio base station. In some embodiments, the access point 102 may include one or more radio access units that provide service (e.g., cellular data service) to a user device 104 within a geographic area surrounding the access point 102 (e.g., a cell). The network architecture 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point. In some embodiments, a group of neighboring base stations/access points 102 may be managed by a base station controller (not shown).

An access point 102 implemented as a base station may include one or more transmission mechanisms (e.g., a radio transceiver) capable of enabling wireless communication with a number of user devices. Such base stations may be distributed over an area in a sufficiently dense manner such that user devices (e.g., mobile communication devices) in communication with the network can communicate with each other or with a terrestrial network. In some embodiments, the access point 102 may include one or more sensors configured to collect information about the access point 102 itself or an environment in which the access point 102 is situated. Additionally, the access point 102 may include one or more mechanical means of adjusting/configuring components of the equipment node. For example, the equipment node may include a radio antenna as well as a motorized mechanism for adjusting a position of the radio antenna.

An access point 102 implemented as a base station can wirelessly communicate with the user devices 104 within wireless communication range via one or more base station antennas. A local network 108 associated with an access point 102 can be divided into sectors making up only a portion of the that network 108. The architecture 100 can include base stations of different types (e.g., macro and/or small cell base stations). In some implementations, there can be overlapping geographic coverage areas (e.g., cells) for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.). In some embodiments, the network 108 may operate using a fixed wireless access (FWA) connection. FWA is a type of 5G or 4G LTE wireless technology that enables fixed broadband access using radio frequencies rather than cables.

The user device 104 can correspond to or include devices capable of communication using various connectivity standards. For example, a 5G communication channel can use millimeter wave (mmW) access frequencies of 28 GHz or more. In some implementations, a user device 104 can operatively couple to an access point 102 over a long-term evolution/long-term evolution-advanced (LTE/LTE-A) communication channel, which is referred to as a 4G communication channel. In some non-limiting examples, user devices can include handheld mobile devices (e.g., smartphones, portable hotspots, tablets, etc.); laptop devices; wearable devices; drones; vehicles with wireless connectivity; head-mounted displays with wireless augmented reality/virtual reality (AR/VR) connectivity; portable gaming consoles; wireless routers, gateways, modems, and other fixed-wireless access devices; wirelessly connected sensors that provides data to a remote server over a network; IoT devices such as wirelessly connected smart home appliances, etc.

A user device 104 can communicate with various types of access points and network equipment at the edge of a network 106 including macro eNBs/gNBs, small cell eNBs/gNBs, relay base stations, and the like. A user device can also communicate with other user devices either within or outside the same coverage area of a base station via device-to-device (D2D) communications.

A communication link between a user device 104 and an access point 102 may include uplink (UL) transmissions from a user device 104 to an access point 102, and/or downlink (DL) transmissions from an access point 102 to a user device 104. The downlink transmissions can also be called forward link transmissions while the uplink transmissions can also be called reverse link transmissions. Each communication link includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links can transmit bidirectional communications using frequency division duplex (FDD) (e.g., using paired spectrum resources) or Time division duplex (TDD) operation (e.g., using unpaired spectrum resources). In some implementations, the communication links include LTE and/or mmW communication links.

User device 104 may include a number of software applications 110, each of which, when executed, may cause the user device to transmit a number of data packets over the network 108 to the access point 102. In some cases, the number of data packets may be directed by the user device 104 to a target destination device 112 that is reachable over the network 106. For example, given that a software application is supported by a remote server (e.g., a destination device 112), the software application may cause the user device to send data packets to that remote server. A destination device 112 may include any suitable computing device configured to receive network data as implemented herein.

In some embodiments, the network 106 may be a core network that is managed by a core management device (not shown) that provides, manages, and controls security services, user authentication, access authorization, tracking, Internet Protocol (IP) connectivity, and other access, routing, or mobility functions. The access points 102 may interface with a network managed by a core management device through a first set of backhaul links (e.g., S1 interfaces) and can perform radio configuration and scheduling for communication with the user devices 104 or can operate under the control of a base station controller (not shown). In some examples, the access points 102 can communicate with each other, either directly or indirectly (e.g., through the network), over a second set of backhaul links (e.g., X1 interfaces), which can be wired or wireless communication links.

The network architecture 100 can include a 5G network and/or an LTE/LTE-A or other network. In an LTE/LTE-A network, the term eNB is used to describe the access points 102, and in 5G new radio (NR) networks, the term gNBs is used to describe the access points 102 that can include mmW communications. The network architecture 100 can thus form a heterogeneous network in which different types of base stations provide coverage for various geographic regions. For example, each access point 102 can provide communication coverage for a local network 108 that forms a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by user devices that have service subscriptions with a wireless network service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by user devices that have service subscriptions with the network provider of network 106. A femto cell covers a relatively smaller geographic area (e.g., a home) and can provide restricted access by user devices having an association with the femto unit (e.g., user devices in a closed subscriber group (CSG), user devices for users in the home). A base station can support one or multiple (e.g., two, three, four, and the like) cells (e.g., component carriers). All fixed transceivers noted herein that can provide access to the network 106 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a user device 104 and the access points 102 or core network 106 supporting radio bearers for the user plane data. At the Physical (PHY) layer, the transport channels are mapped to physical channels.

In embodiments, the network 106 may be partitioned into a number of network slices 114, with each of the individual network slices consisting of one or more bandwidth parts dedicated to a type of network traffic. For example, one network slice 114 of the number of network slices may be a range of bandwidth frequencies that is dedicated to communicating data packets between Internet of Things (IoT) devices to their respective support servers. The use of network slices to communicate dedicated traffic generally allows for the network slice to be optimized for that type of traffic. More particularly, each network slice may be configured to accommodate a particular type of network traffic. By way of illustration, one network slice may be configured to optimize transmission of network traffic that requires significant bandwidth but is not latency-sensitive (e.g., download network traffic). Another network slice may be configured to optimize transmission of network traffic that is latency sensitive. In some cases, a default network slice may be maintained that is configured to handle a variety of different network traffic types without optimizing any particular aspect.

Additionally, the network 108 may also be partitioned into a number of network slices 116, with each of those individual network slices consisting of one or more bandwidth parts dedicated to a type of network traffic.

In operation, network traffic transmitted between a user device 104 and a destination device 112 is transmitted over a network slice that is optimized for transmission of a type or category associated with that network traffic. In embodiments, such network traffic may be allocated to an appropriate network slice based on a tag assigned to that network traffic. For example, the network traffic may include a header (or other suitable indicator data) that includes a data field that stores a value representative of a particular tag assigned to that network traffic. In this example, a device (e.g., user device 104 and/or access point 102) may, upon receiving such network traffic, retrieve information about the tag from the header and allocate that network traffic to a respective network slice associated with that tag. In some cases, if network traffic received at the device does not include such a tag, the device may allocate that network traffic to a default network slice, which is a network slice that is not configured to be optimized for any particular type of network traffic.

In the example network architecture 100 as depicted in FIG. 1, network traffic may be generated by an application 110 that is installed upon, and executed from, a user device 104. Such network traffic may be assigned a tag by the application 110 that generated it. However, some software applications (e.g., legacy software applications) may not be configured to assign such a tag to its network traffic. In conventional systems, such network traffic may simply be allocated to the default network slice, which results in suboptimal network traffic transmission. In some cases, untagged network traffic may be assigned a tag by an access point 102 that receives it. However, this still results in inefficient transmission of the network traffic between the user device 104 and the access point 102.

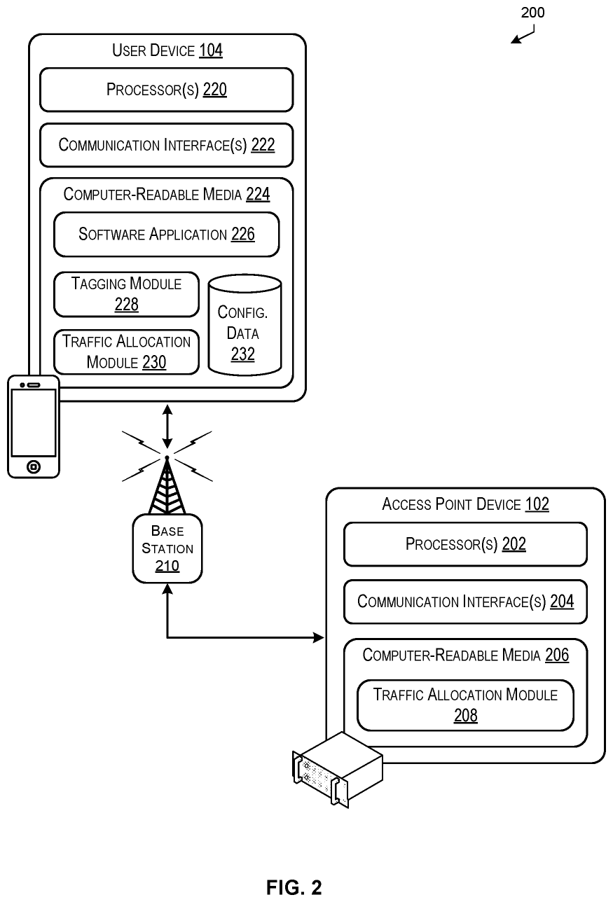

In embodiments, the user device may include a tagging module (described in greater detail with respect to FIG. 2 below) that is configured to assign a tag to network traffic that is initially untagged. Accordingly, network traffic that is generated on the user device 104, even if initially untagged, can be assigned a tag and subsequently allocated to an appropriate network slice upon transmission by the user device 104.

The illustrative network architecture 100 may incorporate, by way of example, CDMA2000 based mobile wireless network components (e.g., AAA service for performing user authentication and providing user profiles) and includes data services delivered via one or more data access protocols, such as EV-DO, EV-DV or the like. Other embodiments include a wireless access network complying with one or more of LTE, WCDMA, UMTS, GSM, GPRS, EDGE, Wi-Fi (i.e., IEEE 802.11x), Wi-MAX (i.e., IEEE 802.16), or similar telecommunication standards configured to deliver voice and data services to mobile wireless end user devices such as, a user device 104 depicted in FIG. 1 carrying out wireless communications via an access point 102. Such a mobile wireless network system may include hundreds or thousands of such base stations.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

FIG. 2 depicts a component diagram of an example system to be implemented in a network (e.g., a mobile network) in order to enable allocation of network traffic to a network slice in accordance with at least some embodiments. As depicted in FIG. 2, an access point 102 is in wireless communication with a user device 104 operated by a user. Additionally, as described elsewhere, the access point 102 may be further in communication with one or more backend servers (e.g., a core management device) and/or an external network.

In some embodiments, an exemplary access point 102 may be an example of the access point 102 as described in relation to FIG. 1 above. In some embodiments, the access point 102 is implemented on, or in direct communication with, a base station 210. It should be noted that such an access point (or any other described computing component) may include a single computing device (e.g., a server device) or a combination of computing devices. In some cases, the access point may be implemented as a virtual device/system (e.g., via virtual machines implemented within a cloud computing environment).

As illustrated, the access point 102 may include one or more hardware processors 202 configured to execute one or more stored instructions. Such processor(s) 202 may comprise one or more processing cores. Further, the access point 102 may include one or more communication interfaces 204 configured to provide communications between the access point 102 and other devices, such as the user device 104 or any other suitable electronic device.

The access point 102 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the access point 102. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the access point 102 to perform various operations described herein. For example, the computer-readable media 206 may include some combination of components configured to implement the described techniques. Particularly, the access point 102 may include a component configured to allocate network traffic to a network slice (e.g., traffic allocation module 208). Additionally, the computer-readable media 206 may further maintain one or more databases, such as a database of information maintained in relation to categorization of network traffic tags to corresponding network slices.

A traffic allocation module 208 may be configured to, when executed by the processors 202, provide routing and switching functionality in relation to network traffic. For example, the traffic allocation module 208 may be configured to analyze network traffic in order to allocate that network traffic to a particular network slice. In embodiments, when network traffic is received at an access point that is directed to a destination device reachable over a network, the traffic allocation module 208 is configured to identify a tag associated with that network traffic. In some cases, the traffic allocation module 208 first determines if the network traffic is already associated with a tag. In embodiments, this may involve inspecting a header or other data associated with the network traffic to identify the tag from one or more data values.

Once a tag has been identified for the network traffic, the traffic allocation module 208 is configured to determine a network slice associated with that tag. The traffic allocation module 208 then configures the network traffic in accordance with the requirements of the identified respective network slice and transmits the network data to its intended destination device over that network slice. If the network traffic is not currently associated with a tag, then the traffic allocation module 208 may be configured to allocate that network traffic to a default network slice.

The exemplary user device 104 may be an example of a user device 104 as described in relation to FIG. 1 above. As noted elsewhere, a user device 104 may include any suitable electronic device configured to interact with a network.

Similar to the access point 102, the user device 104 may include one or more hardware processors 220 configured to execute stored instructions. Such processor(s) 220 may comprise one or more processing cores. Further, the user device 104 may include one or more communication interfaces 222 configured to provide communications between the user device 104 and other devices, such as an access point 102 or another suitable electronic device.

Similar to the access point 102, the user device 104 may include computer-readable media 224 that stores various executable components (e.g., software-based components, firmware-based components, etc.). The computer-readable media 224 may store components to implement functionality described herein.

The computer-readable media 224 may include portions, or components, that configure the user device 104 to perform various operations described herein. For example, the computer-readable media 224 may include some combination of components configured to implement the described techniques. In embodiments, the computer-readable media 224 of the user device 104 may include one or more software application 226. The computer-readable media 224 may further include a component configured to assign a tag to network traffic generated by a software application (e.g., tagging module 228) and a component configured to allocate network traffic to a network slice (e.g., traffic allocation module 230). Additionally, the computer-readable media 224 may further maintain one or more databases, such as a database of information maintained in relation to categorization of network traffic generated by a software application (e.g., configuration data 232).

A software application 226 may be any suitable set of computer executable instructions that causes the user device to perform a function and may be an example of the software application 110 as described in relation to FIG. 1 above. In embodiments, the software application 226 may be supported by a remote server. In other words, when executed, the software application may cause the user device 104 to communicate with a remote server to perform at least a portion of the functionality provided by the software application 226. The network traffic generated during such a communication may be transmitted to the access point to be routed to its intended destination device.

A tagging module 228 may be configured to, when executed by the processors 220, assign an appropriate tag to network traffic generated by a software application 226 operating on the user device 104. In some cases, an instance of the tagging module may be instantiated in conjunction with an instance of a software application 226. For example, when a software application 226 is executed, an instance of the tagging module 228 may be instantiated within an application wrapper that also includes an instance of the software application 226. In such an example, network generated by the instance of the software application is routed through the tagging module 228 automatically before leaving the application wrapper.

In embodiments, the tagging module 228 retrieves tag assignment information from configuration data 232. More particularly, the tagging module 228 may determine an appropriate tag to be assigned to network traffic based on one or more conditions that are satisfied by that network traffic. For example, a particular port and/or channel may be associated with a tag, such that network traffic determined to be directed to the port and/or channel is assigned that tag. In some cases, the configuration data 232 may include tag information that is specific to a software application 226. For example, different types of network traffic data generated by a software application 226 may be tagged differently based on attributes of the respective network traffic.

In some embodiments, the tagging module 228 may operate in conjunction with a trained machine learning model. For example, upon receiving untagged network traffic, the tagging module 228 may provide information collected in relation to that untagged network traffic as input to a machine learning model that has been trained to correlate network traffic to a respective tag.

A traffic allocation module 230 may be configured to, when executed by the processors 220, allocate network traffic to an appropriate network slice of a local network based on a tag determined to be associated with the network traffic. The network traffic may then be conveyed wirelessly to an access point 102 (e.g., via a base station 210) over the allocated network slice.

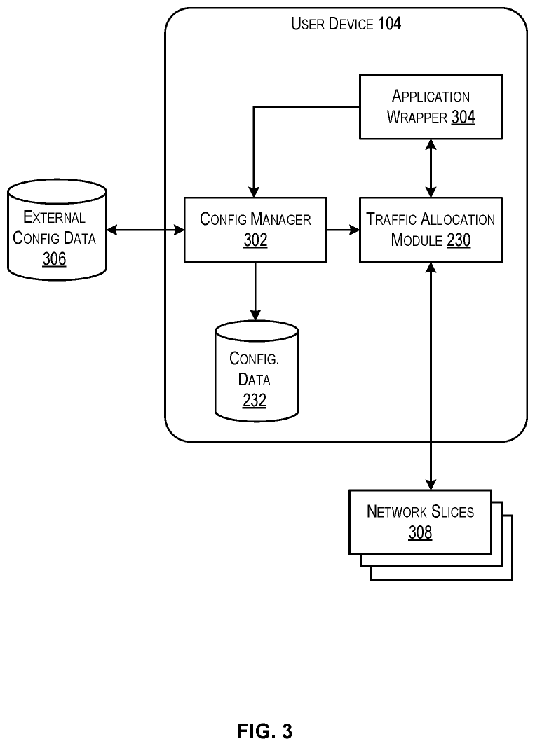

FIG. 3 depicts a block diagram illustrating a process for allocating network traffic to a network slice as implemented within a user device in accordance with at least some embodiments. As noted elsewhere, a memory (e.g., computer-readable media) of a user device 104 may include one or more modules configured to perform various functions as described herein. Particularly, the memory may include a traffic allocation module 230 as well as configuration data 232 as described in relation to FIG. 2 above. Additionally, the memory may include a configuration manager 302. In some cases, when a software application (e.g., software application 226 as described in relation to FIG. 2 above) is executed, an application wrapper 304 may be instantiated in the memory of the user device 104 as well.

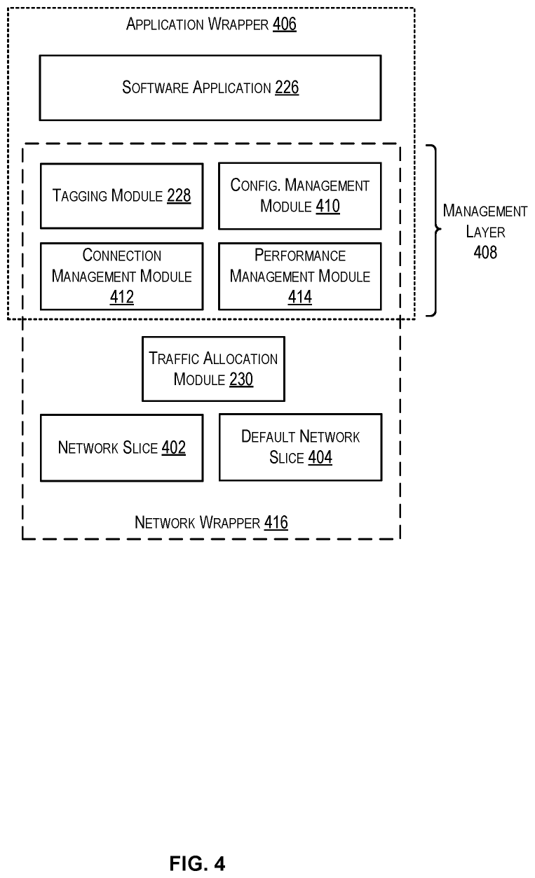

In embodiments, the configuration manager 302 is configured to manage configuration data to be used in assigning tags/network slices to network traffic. In some embodiments, the configuration manager 302 may be configured to identify configuration settings associated with a particular software application to be implemented within the application wrapper 304. In such cases, the configuration settings implemented within the application wrapper 304 may be used by a tagging module (e.g., tagging module 228) to assign tags to untagged network traffic that is generated within the application wrapper. This is described in greater detail with respect to FIG. 4 below.

In some embodiments, the configuration manager may be configured to update the configuration data 232 that is stored on the user device 104. In some embodiments, the configuration data 232 may be updated based on external configuration data 306 that is received from another entity (e.g., a remote computing device).

In some embodiments, the configuration manager may be configured to update the configuration data 232 based on information generated using one or more trained machine learning model.

In operation, network traffic generated by the application wrapper 304 is received at a traffic allocation module 230. Such network traffic may include an indication of a tag assigned to that network traffic. In some cases, such a tag may be indicated in a header associated with the network traffic.

Upon receiving network traffic, the traffic allocation module 230 is configured to identify one of multiple network slices 308 to which the network traffic is to be assigned. The traffic allocation module 230 may then configure the network traffic in accordance with any requirements/settings associated with the identified network slice and then transmit the network traffic over that network slice.

FIG. 4 depicts a component diagram illustrating a number of components that may be implemented to achieve tagging and allocation of network traffic in accordance with embodiments. More particularly, the component diagram depicts information about a number of components (that may be implemented as some combination of hardware and/or software) that may be implemented within a network architecture as described herein.

In embodiments, network traffic generated on a user device may be allocated to an appropriate network slice by a traffic allocation module 230 as described elsewhere. More particularly, the traffic allocation module 230 may be configured to allocate network traffic generated on the user device (e.g., that is destined outside of that user device) to an appropriate network slice over which it is conveyed to its destination. As noted elsewhere, network traffic may be allocated based on a tag assigned to that network traffic. If the network traffic is assigned a tag, then that network traffic is allocated to a network slice 402 associated with that tag. As noted elsewhere, the network slice 402 may be configured to optimally convey a particular type of network traffic. Otherwise, if the network traffic is not assigned a tag, then that network traffic may be allocated to a default network slice 404 that is not configured in relation to any particular type of network traffic.

In embodiments, an application wrapper 406 is instantiated upon execution of a software application 226 on a user device. The application wrapper 406 may include the software application 226 as well as a software management layer 408. An application wrapper 406 may be any suitable data structure or software that contains (e.g., “wraps around”) other data or software, so that the contained elements can operate in an implemented system. The software management layer may include a number of network management components. For example, a software management layer 408 may include one or more of a tagging module 228 (which may be an example of tagging module 228 as described in relation to FIG. 2 above), a configuration management module 410, a connection management module 412, and/or a performance management module 414.

As noted elsewhere, the tagging module 228 may be configured to assign a tag to network traffic that is generated by the software application 226 within the application wrapper 406. In some cases, when the application wrapper 406 is instantiated, it may be provided with information about network traffic tags that are relevant to the software application 226 for which the application wrapper 406 was instantiated. In some cases, the tagging module 228 may assign a tag to network traffic in accordance with information generated by another component, such as the configuration management module 410.

A configuration management module 410 may be configured to identify attributes of network traffic generated by the software application 226 to be assigned to a tag. In some cases, this may involve identifying one or more data attribute values as being associated with a tag within configuration data stored in a memory of the user device.

A connection management module 412 may be configured to identify a number of network slices that are currently available for use. In some cases, these may be network slices that are available for use by the user device on which the application wrapper 406 has been instantiated. In some cases, these may be network slices that are available for use by the software application 226. In some cases, these may be network slices that are currently available/unfettered. In embodiments, the tags assigned to the network traffic within an application wrapper 406 by the tagging module 228 may be limited to just those tags that correspond to network slices that are determined to be available.

A performance management module 414 may be configured to determine key performance indicators (KPIs) associated with network traffic conveyed over one or more network slices. In some embodiments, when the performance management module 414 detects a degradation in the KPIs associated with a particular network slice, it may be configured to identify an alternative network slice to be used to convey network traffic. In some cases, information obtained by the performance management module 414 may be used by the tagging module 228 to assign a tag to network traffic.

In some embodiments, a network wrapper 416 may be instantiated to include the management layer 408 as well as various components, such as the traffic allocation module 230. As a result of the use of an application wrapper 406, the user device would detect the instance of the software application 226 as being an application having advanced network slice capabilities even when that software application is otherwise unable to use network slice technology.

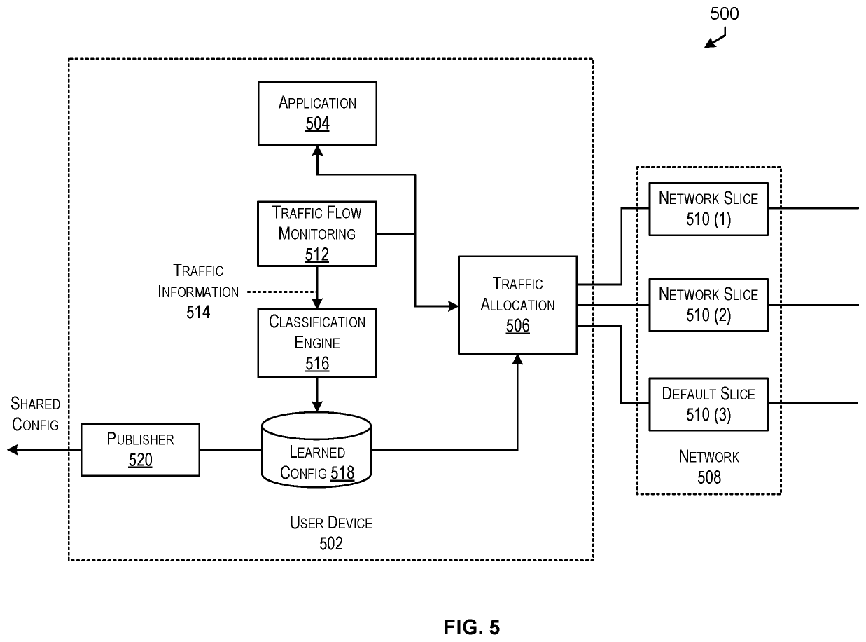

FIG. 5 depicts a block diagram illustrating a process for updating configuration data to be used in tagging on a user device in accordance with some embodiments. As depicted, the process 500 may be performed primarily upon a user device 502 and may involve interactions between various components as implemented within a memory of that user device 502.

In embodiments, the process 500 may relate to network traffic conveyed between an application 504 and a module for performing traffic allocation 506 (e.g., traffic allocation module 230 as described in relation to FIG. 2 above). The application 504 may refer to a software application (e.g., software application 226 as described in relation to FIG. 2 above) or it may refer to an application wrapper (e.g., application wrapper 406 as described in relation to FIG. 4 above).

As noted elsewhere, one or more routing/switching operations may be performed on network traffic by a traffic allocation module (e.g., traffic allocation module 230). The traffic allocation module may manage access to a network 508 that includes a number of network slices 510 (1-3). Each of the individual network slices 510 may be optimized to convey a particular type of network traffic as noted elsewhere.

In the process 500, as network traffic is conveyed between an application 504 and a traffic allocation module is monitored via a traffic flow monitoring component 512. Such a component may determine one or more attribute data values associated with the network traffic. For example, the traffic flow monitoring component 512 may obtain information about a tag assigned to the network traffic, an origination device/application of the network traffic, an intended destination of the network traffic, KPIs associated with the network traffic, or any other suitable information 514 related to the network traffic.

In embodiments, the traffic information 514 may be provided to a classification engine 516 that is configured to provide classification of network traffic. In embodiments, the classification engine includes one or more machine learning models that have been trained to correlate network traffic attribute values with tags. In some cases, the classification engine 516 uses the traffic information 514 to update learned configuration data 518 that includes information about learned correlations between network traffic types and tags.

In some embodiments, the classification engine 516 may draw correlations between network traffic and a respective tag based on similarities between attribute values of the monitored network traffic and attribute values associated with a known tag correlation. For example, in some cases the classification engine 516 may determine that network traffic originating at the application 504 is most similar to network traffic that is assigned a particular tag within the configuration data based on attribute values for each of the respective network traffic. In this scenario, the classification engine 516 may update the learned configuration data 518 to include an indication that network traffic originating at the application (and having the corresponding attribute values) is to be assigned the corresponding tag.

In some embodiments, the classification engine 516 may draw correlations between network traffic and a respective tag based on information about network traffic directed to the application. For example, the application 504 may be in communication with a destination device (e.g., a remote server). In this example, the user device 502 may receive network traffic that originates at the destination device that is directed to the application 504. In such cases, the classification engine 516 may draw a correlation between a tag associated with the received network traffic and the application. In some cases, that correlation may be further defined based on a port or channel associated with the network traffic, in that network traffic generated by the application is assigned the tag when it is also associated with the port or channel.

When the learned configuration data 518 is updated to include new information about correlations between network traffic and a tag, that learned configuration data 518 may be provided to at least one second computing device. In some cases, a publisher module 520 may be configured to convey the learned configuration data 518 to a second user device or to a remote server (e.g., a core management server).

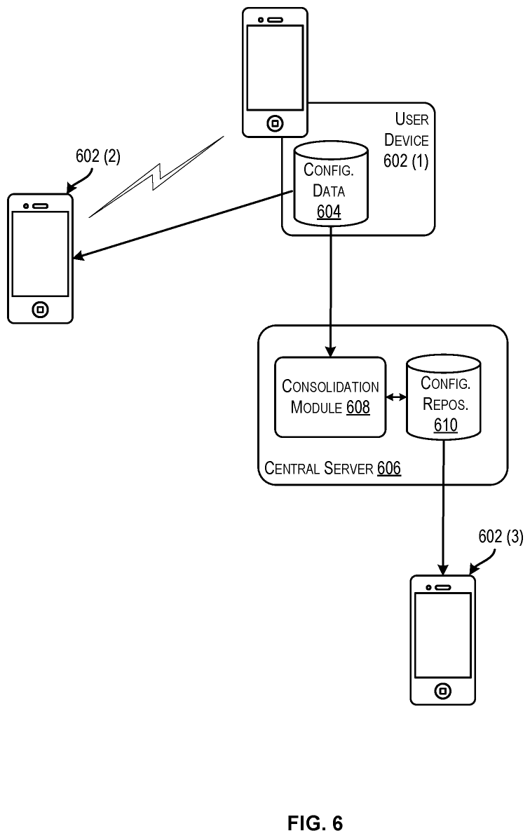

FIG. 6 depicts a block diagram illustrating exemplary techniques for provisioning configuration data onto one or more user devices in accordance with some embodiments. Multiple user devices 602 (1-3) may operate on a network (e.g., a cellular network). In some embodiments, one or more of the user devices 602 may generate configuration data that relates to network traffic handled by that user device (e.g., via process 500 as described in relation to FIG. 5 above).

In some embodiments, a user device 602 may convey one or more learned correlations between network traffic attribute values and tags stored in configuration data 604 to at least one second user device. Such learned correlations may correspond to the learned configuration data 518 as generated by the process 500 described in relation to FIG. 5 above. In some cases, a user device 602 (1) may convey only the portion of the configuration data 604 containing those correlations that it determined (e.g., using a trained machine learning model). In other cases, the user device 602 (1) may convey the configuration data 604 that it has stored in its entirety.

In some embodiments, the user device 602 (1) conveys the configuration data to another user device 602 (2) with which it is in direct wireless communication. For example, the user device 602 (1) may generate configuration data 604 upon determining correlations between network traffic generated by at least one application executed on the user device 602 (1) and a tag. Upon generating such configuration data, and upon detecting that the user device 602 (1) has established communication with a second user device 602 (2), the user device 602 (1) may transmit that configuration data to the user device 602 (2) to be used by that user device in assigning tags to network traffic.

In some embodiments, the user device 602 (1) conveys the configuration data to a central server 606 with which it is in communication. In these embodiments, the central server 606 may consolidate the configuration data 604 received from multiple user devices (e.g., via a consolidation module 608) into a common configuration data repository 610. In some embodiments, this may require resolution of conflicting configuration data. For example, where multiple configuration data includes information about network traffic associated with the same application, port, channel, and/or destination, etc., then the consolidation module 608 may attempt to determine which set of configuration data is correct. In some embodiments, the version appearing most frequently (e.g., received from the highest number of user devices) is selected as the correct version.

Once the configuration data received from multiple user devices has been consolidated into a common configuration data repository 610, the central server 606 may distribute the configuration data to each of a number of user devices 602 (3). In some embodiments, the configuration data provided by the central server 606 to a user device 602 may be used to overwrite, or replace, configuration data 604 stored upon that user device.

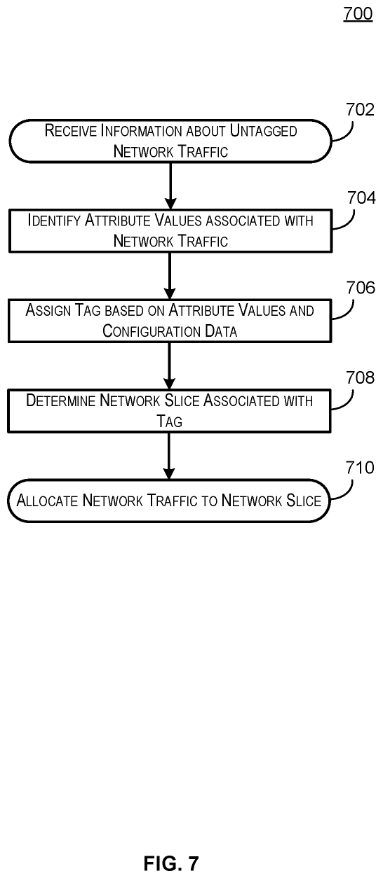

FIG. 7 depicts a flow diagram illustrating an exemplary process for generating tag assignment data to be used in network traffic allocation in accordance with at least some embodiments. The process 700 may be performed by a user device, such as the user device 104 as described in relation to FIG. 2 above. As noted elsewhere, the user device may be a mobile device that operates using a network connection, such as a cellular phone.

In some embodiments, the user device may be in communication with an access point implemented in a base station that manages a FWA network providing wireless service to user devices located within wireless communication range. In these embodiments, the FWA network is partitioned into a number of network slices that includes the network slice.

At 702, the process 700 may involve receiving information about network traffic that is not assigned a tag. In embodiments, the network traffic is generated by a software application installed upon, and executed from, the user device.

At 704, the process 700 may involve identifying attribute values associated with the untagged network traffic. In some cases, the set of attribute values comprises at least one of a port or channel associated with the network traffic. In some cases, the set of attribute values comprises one or more of a software application from which the network traffic originated or a destination of the network traffic.

At 706, the process 700 may involve assigning a tag to the network traffic based on the identified attribute values as well as configuration data stored on the user device. In some embodiments, the tag is assigned based at least in part on a destination device associated with the network traffic. In some embodiments, the tag is assigned based at least in part on a software application that generated the network traffic. In embodiments, the tag is determined using one or more machine learning models based on a degree of similarity between the information about the network traffic and second information about second network traffic associated with the tag in the configuration data.

At 708, the process 700 may involve determining a network slice associated with the tag. In embodiments, the network slice is optimized for a type or category of network traffic. In those embodiments, the tag may be determined by virtue of the network traffic being of that type or category of network traffic.

At 710, the process 700 may involve allocating the network traffic to the network slice. The network traffic may then be conveyed to an access point over the allocated network slice.

In some embodiments, the process 700 may further involve updating the configuration data based on the assigned tag. In embodiments, the configuration data is updated to include the set of attribute values and the tag. In some cases, the updated configuration data is provided to at least one second user device. For example, the updated configuration data may be provided to a second user device to be used by that second user device in assigning tags to network traffic. In another example, the updated configuration data is provided to a central server that consolidates that configuration data into a common configuration data repository. In this example, the process 700 may further involve receiving updated configuration data from the central server that includes a correlation between the tag and the information about the network slice.

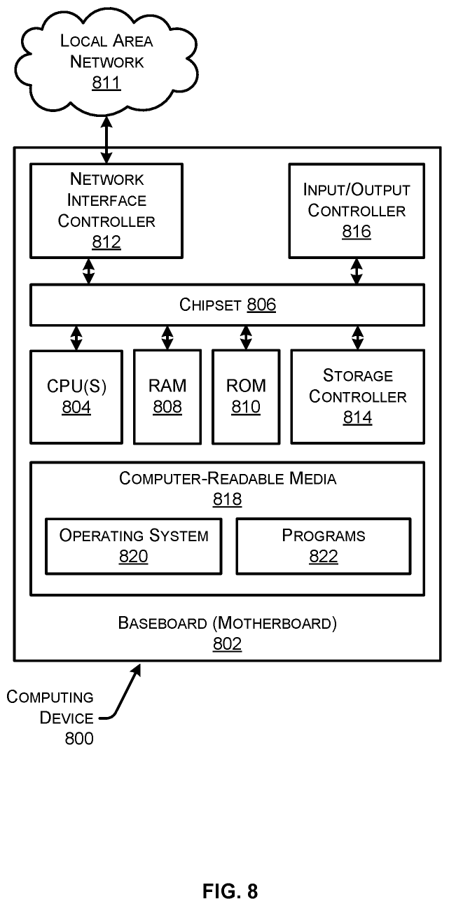

FIG. 8 shows an example computer architecture for a computing device 800 capable of executing program components for implementing the functionality described above. Such a computing device 800 may be implemented as user device (e.g., user device 104) or as an access point (e.g., access point 102) as described herein. The computer architecture shown in FIG. 8 illustrates a conventional server computer, workstation, desktop computer, laptop, tablet, network appliance, e-reader, smartphone, or other computing device, and can be utilized to execute any of the software components presented herein. The computing device 800 may, in some examples, correspond to a physical server as described herein, and may comprise networked devices such as servers, switches, routers, hubs, bridges, gateways, modems, repeaters, access points, etc.

The computing device 800 includes a baseboard 802, or “motherboard,” which is a printed circuit board to which a multitude of components or devices can be connected by way of a system bus or other electrical communication paths. In one illustrative configuration, one or more central processing units (“CPUs”) referred to as processors 804 operate in conjunction with a chipset 806. The processors 804 can be standard programmable processors that perform arithmetic and logical operations necessary for the operation of the computing device 800.

The processors 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the processors 804 and the remainder of the components and devices on the baseboard 802. The chipset 806 can provide an interface to a RAM 808, used as the main memory in the computing device 800. The chipset 806 can further provide an interface to a computer-readable storage medium such as a read-only memory (“ROM”) 810 or non-volatile RAM (“NVRAM”) for storing basic routines that help to startup the computing device 800 and to transfer information between the various components and devices. The ROM 810 or NVRAM can also store other software components necessary for the operation of the computing device 800 in accordance with the configurations described herein.

The computing device 800 can operate in a networked environment using logical connections to remote computing devices and computer systems through a network, such as the network 811. The chipset 806 can include functionality for providing network connectivity through a NIC 812, such as a gigabit Ethernet adapter. The NIC 812 is capable of connecting the computing device 800 to other computing devices over the network 811. It should be appreciated that multiple NICs 812 can be present in the computing device 800, connecting the computer to other types of networks and remote computer systems.

The computing device 800 can be connected to a storage device 818 that provides non-volatile storage for the computer. The storage device 818 can store an operating system 820, programs 822, and data, which have been described in greater detail herein. The storage device 818 can be connected to the computing device 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computing device 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 can further read information from the storage device 818 by detecting the physical states or characteristics of one or more particular locations within the physical storage units.

In addition to the mass storage device 818 described above, the computing device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 800. In some examples, the operations performed by devices as described herein may be supported by one or more devices similar to computing device 800. Stated otherwise, some or all of the operations performed by an edge device, and/or any components included therein, may be performed by one or more computing device 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computing device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computing device 800.

In one embodiment, the storage device 818 or other computer-readable storage media is encoded with computer-executable instructions which, when loaded into the computing device 800, transform the computer from a general-purpose computing system into a special-purpose computer capable of implementing the embodiments described herein. These computer-executable instructions transform the computing device 800 by specifying how the CPUs (e.g., processors 804) transition between states, as described above. According to one embodiment, the computing device 800 has access to computer-readable storage media storing computer-executable instructions which, when executed by the computing device 800, perform the various processes described above with regard to the other figures. The computing device 800 can also include computer-readable storage media having instructions stored thereupon for performing any of the other computer-implemented operations described herein.

The computing device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computing device 800 might not include all of the components shown in FIG. 8, can include other components that are not explicitly shown in FIG. 8, or might utilize an architecture completely different than that shown in FIG. 8.

As described herein, the computing device 800 may include one or more hardware processors 804 (processors) configured to execute one or more stored instructions. The processors 804 may comprise one or more cores. Further, the computing device 800 may include one or more network interfaces configured to provide communications between the computing device 800 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 811. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 822 may comprise any type of programs or processes to perform the techniques described in this disclosure. The programs 822 may comprise any type of program that cause the computing device 800 to perform techniques for communicating with other devices using any type of protocol or standard usable for determining connectivity.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, one or more module executed on the computing device 800 may also include computer executable instructions that, when executed by processor(s), cause computing device 800 to perform the techniques described herein. To do so, in some embodiments, a module may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, one or more module included on the computing device 800 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a user device, information about network traffic that is untagged;
identifying, by the user device within the information about the network traffic, a set of attribute values associated with the network traffic;
assigning, based on the set of attribute values and based on configuration data stored on the user device, a tag to the network traffic;
determining a network slice associated with the tag; and
transmitting the network traffic to an access point over the network slice associated with the tag.

2. The method of claim 1, wherein the tag is assigned based at least in part on a destination device associated with the network traffic.

3. The method of claim 1, wherein the tag is assigned based at least in part on a software application that generated the network traffic.

4. The method of claim 1, wherein the tag is determined using one or more machine learning models.

5. The method of claim 4, wherein the tag is determined based on a degree of similarity between the information about the network traffic and second information about second network traffic associated with the tag in the configuration data.

6. The method of claim 1, wherein updated configuration data is generated to include the set of attribute values and the tag.

7. The method of claim 6, wherein the updated configuration data is provided to at least one second computing device.

8. The method of claim 7, wherein the at least one second computing device comprises a second user device, wherein the updated configuration data is used by the second user device to assign a tag to second network traffic.

9. The method of claim 7, wherein the at least one second computing device comprises a central server, and the updated configuration data is consolidated into a common configuration data repository.

10. A mobile device comprising:
one or more processors; and
one or more non-transitory computer-readable media storing computer-executable instructions that, when executed by the one or more processors, cause the mobile device to perform operations comprising:
receiving information about network traffic that is untagged;
identifying, within the information about the network traffic, a set of attribute values associated with the network traffic;
assigning, based on the set of attribute values and based on configuration data stored on the mobile device, a tag to the network traffic;
determining a network slice associated with the tag; ands
transmitting the network traffic to an access point over the network slice associated with the tag.

11. The mobile device of claim 10, wherein the access point is implemented in a base station that manages a fixed wireless access (FWA) network in communication with the mobile device.

12. The mobile device of claim 11, wherein the FWA network is partitioned into a number of network slices that includes the network slice.

13. The mobile device of claim 10, wherein the set of attribute values comprises one or more of a software application from which the network traffic originated or a destination of the network traffic.

14. The mobile device of claim 10, wherein the operations further comprise providing an indication of the tag and information about network traffic to at least one second computing device.

15. The mobile device of claim 14, wherein the operations further comprise receiving, from the at least one second computing device, updated configuration data that includes the indication of the tag and the information about network traffic.

16. The mobile device of claim 10, wherein the network slice is optimized for a type or category of network traffic.

17. One or more non-transitory computer-readable media storing computer-executable instructions that, when executed by one or more processors, cause the one or more processors to perform operations comprising:
receiving information about network traffic that is untagged;
identifying, within the information about the network traffic, a set of attribute values associated with the network traffic;
assigning, based on the set of attribute values and based on configuration data stored on the computer-readable media, a tag to the network traffic;
determining a network slice associated with the tag; ands
transmitting the network traffic to an access point over the network slice associated with the tag.

18. The one or more non-transitory computer-readable media of claim 17, wherein the information about the network traffic comprises information about at least one of an application that generated the network traffic or a destination of the network traffic.

19. The one or more non-transitory computer-readable media of claim 17, wherein the tag is assigned using one or more machine learning models based on a degree of similarity between the information about the network traffic and second information about second network traffic associated with the tag in the configuration data.

20. The one or more non-transitory computer-readable media of claim 17, wherein the network slice is optimized for a category of network traffic and the tag is assigned based on the network traffic being of the category of network traffic.
